(19) United States
(12) Patent Application Publication
(10) Pub. No.: US 2003/0095268 A1
(43) Pub. Date: May 22, 2003

(54) System for storing digital data on sheets using a color printer

(76) Inventor: Gerardo Caracas Uribe, Fraccionamiento Prados de Tepeyac (MX)

Correspondence Address: HEWLETT-PACKARD COMPANY, Intellectual Property Administration, P.O. Box 272400, Fort Collins, CO, 80527-2400, US

(21) Appl. No.: 09/976,201

(22) Filed: Oct. 11, 2001

(51) Int. Cl. G06K 15/02; G06F 3/12

(52) U.S. Cl. 358/1.1

(57) ABSTRACT

A system for storing data on a printed sheet employs a processor to divide data into a series of words, each containing a predetermined number of bits. The processor assigns a color for each word of data from a predetermined set of unique colors based on the value of the word. A color printer is used to print a series of regions on a sheet in a two-dimensional pattern corresponding to the colors selected for each word of data. The resulting printed sheet(s) can be read by a color scanner to retrieve the stored data. A processor associated with the scanner determines the color of each region on the sheet and generates a word of data from each region based on its color.

### BACKGROUND OF THE INVENTION

1. Field of the Invention.

The present invention relates generally to the field of digital data storage. More specifically, the present invention discloses a system for storing digital data on paper using a color printer.

2. Statement of the Problem.

A wide variety of media have been used in the past for storing data, such as diskettes, magnetic disks, magnetic tapes, optical disks, CD-ROMs, and DVDs. Each of these prior art approaches has certain advantages and disadvantages. For example, hard disks are relatively fast, but have a fixed capacity and require a significant initial expenditure. Diskettes, tapes, and other removable magnetic media can store large datasets by using multiple diskettes or cartridges, but they tend to be relatively slow and cost can still be a significant factor.

Optical storage media, such as CD-ROMs and DVDs, can store a large amount of data, but require that the user must have a read/write drive. The current cost of a writable CD-ROM (or CD-R) is approximately $0.40 to $1.00, and the cost of a writable/erasable CD-ROM (or CD-RW) is several times that. As a result, the cost of storage media can still be a significant factor.

Therefore, a need exists for a means of storing data at very low cost that does not require a significant investment in hardware.

3. Solution to the Problem.

In contrast to conventional data storage technologies, the present invention employs a conventional color printer and scanner to store and retrieve digital data. Sheets of paper are used as the media for data storage. This invention allows large quantities of digital data to be stored inexpensively on paper. Paper costs approximately about one-half cent per page, which offers a significant cost savings over the prior art.

### SUMMARY OF THE INVENTION

This invention provides a system for storing data on printed sheets. A processor divides the data to be stored into a series of words, each containing a predetermined number of bits. The processor then assigns a color for each word of data from a predetermined set of unique colors based on the value of the word. A printer is used to print a series of regions on a sheet in a two-dimensional pattern corresponding to the colors selected for each word of data. The resulting printed sheet(s) can be read by a scanner to retrieve the stored data. A processor associated with the scanner determines the color of each region on the sheet and generates a word of data from each region based on its color.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a schematic block diagram of a system for printing data on printed sheets.

FIG. 2 is a schematic block diagram of a system for retrieved data from printed sheets.

FIG. 3 is a diagram showing an example of printed data lines 30 and control lines 35 on a printed sheet.

FIG. 4 is a table illustrating combinations of red, green, and blue that can used to define a unique set of colors for each possible value of a byte of data.

### DETAILED DESCRIPTION OF THE INVENTION

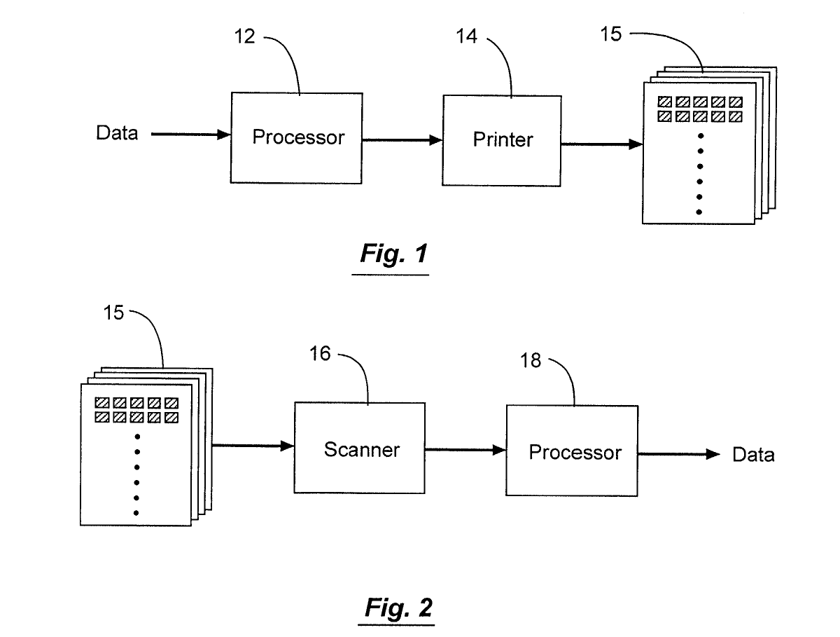

FIG. 1 shows a schematic block diagram of a system for printing data on sheets that incorporates the present invention. A processor 12 receives the data to stored and divides it into a series of words. Each word of data contains a predetermined number of bits of data (e.g., 8 bits or one byte). The number of bits in each word is arbitrary. When dealing with binary data, the maximum number of binary values that can be stored in a word having a length of N bits (where N is a positive integer) is 2^{N}. Thus, an eight-bit word can store 256 binary values ranging from 0 to 255. For example, the processor 12 can be a conventional personal computer, or a microprocessor, or any other type of computer processor.

The processor 12 is programmed to associate a unique color with each of the possible binary values for a word of data. For example, using an eight-bit word, a set of 256 unique colors would be required. In general, a word containing N bits of data requires a set of 2^{N} unique colors. This information can be stored, for example, in the form of a look-up table that is available to the processor 12. The processor assigns a color for each word of data from this set of unique colors determined by the value of the word.

A color printer 14 controlled by the processor 12 prints the assigned colors for the words of data in a predetermined two-dimensional pattern of regions on one or more sheets 15. One colored region is printed for each word of data. For example, the colors can be printed in a two-dimensional array of colored dots. It should be expressly understood that regions of any predetermined size and shape can be printed on the sheet, and that any type of two-dimensional array of regions can be employed, including a two-dimensional grid or any other pattern of regions. Sheets of any size or shape can be employed. Conventional paper is likely to be the least expensive media for printing. However, other types of printable media could be readily substituted.

It may be advantageous to print a printer profile at the top of at least the first sheet containing predetermined parameters to assist in retrieving data from the printed sheet(s) 15. For example, the printer profile may contain information about the color characteristics of the color printer to assist in color matching. In addition, the printer profile may contain information concerning the print resolution, and the number, size, and arrangement of the colored regions printed on each sheet. A single data set can extend over more than one sheet. If so, the printer profile may include the current page number of each sheet and the total number of sheets.

Selection of the set of unique colors used to encode data is largely arbitrary. However, these colors should be as widely separated as possible in terms of their spectral characteristics to help ensure data accuracy. Most color printers generate a spectrum of colors from various combinations of up to three primary colors (e.g., red, green, and blue), plus black, that correspond to the ink reservoirs for the printer. Similarly, each unique color used for storing data can be created using a predetermined weighting of up to three primary colors.

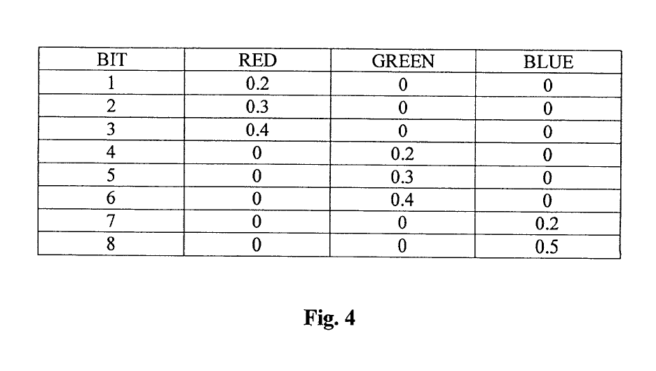

For example, FIG. 4 is a table illustrating one possible set of combinations of red, green, and blue that can used to define a unique set of colors for each possible value of a byte of data. Each color has a value ranging form 0 to 1 in PostScript notation. Any desired combination of bits can be turned on by summing the corresponding RGB values for desired bits in FIG. 4. For example, if the user selects RGB values of:

(0.9, 0.9, 0.7)—bits 12345678 are ON

(0.9, 0.2, 0.0)—bits 1234 are ON and bits 5678 are OFF

(0.0, 0.7, 0.7)—bits 5678 are ON and bits 1234 are OFF

(0.6, 0.3, 0.2)—bits 1357 are ON and bits 2468 are OFF

(0.3, 0.6, 0.5)—bits 2468 are ON and bits 1357 are OFF

Thus, using the RGB combinations in FIG. 4, the user can represent any possible eight-bit word as a unique color. Conversely, each color in the set of 256 colors is uniquely associated with one and only one data value for an eight-bit word.

It should be understood that the RGB values in FIG. 4 are provided merely as one example. Other combinations of RGB values could be readily substituted or other primary colors could be used. However, the following rules apply. The sum of the red value, the sum of the green value, or sum of the blue value for any unique color (i.e., for any possible bit combination) should not exceed one. Using the example provided in FIG. 4, the maximum red value is 0.9, the maximum green value is 0.9, and the maximum blue value is 0.7, which occurs when bits 12345678 are ON. In addition, there should be a one-to-one correspondence between the possible values for a word of data and the colors in the set of unique colors. In other words, no eight-bit word should have the same sum of RGB values as any other eight-bit combination. The accompanying Appendix is a PostScript listing of an implementation of the table in FIG. 4.

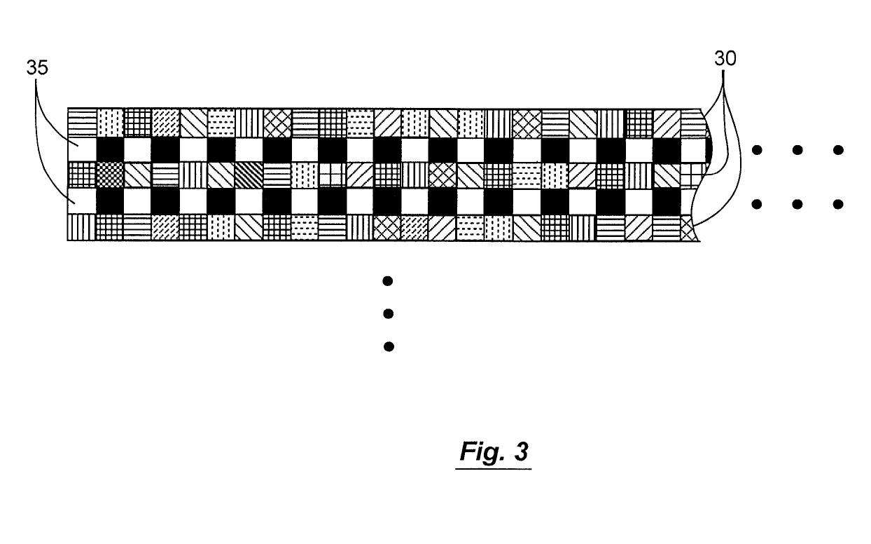

FIG. 3 shows an example of a possible layout of the printed regions on a sheet 15. The printed regions are a series of colored dots arranged in horizontal data lines 30 extending across the printed sheet 15. The color of each dot represents one word of data, as previously described. Densities of up to 600-1200 dots per inch along each line may be possible with conventional color printers. However, to accurately retrieve data from the printed sheets 15, there should be some means for separating the horizontal data lines 30, as well as separating the individual color dots within each horizontal data line 30. For example, suppose that two adjacent dots on a line have the same color. The data retrieval system must have some means for determining whether this is one byte of data or two. To address this problem, the layout shown in FIG. 3 includes a horizontal control line 35 between each pair of adjacent data lines 30. Each control line 35 has alternating white and black regions in vertical alignment with the colored dots of the horizontal data lines 30 above and below. When a printed sheet is scanned by the data retrieval system, the transitions between black and white along the control lines 35 are highly visible and can be used to identify the boundaries of each printed data region in the neighboring data lines 30.

FIG. 2 is a schematic block diagram of a system for retrieved data from printed sheets 15. A color scanner 16 scans each sheet 15 and outputs corresponding color information in digital form for each pixel in the scanned image. For example, a conventional color scanner can be used for this purpose. A computer processor 18 receives and processes the color information from the scanner 16 to determine the color of each printed region. As previously discussed, the processor 18 may read the printer profile from each sheet to decode parameters for reading the remaining data. The processor 18 determines the color of each printed region on the sheet 15 and matches it against the set of unique colors used for encode data. The processor 18 then generates one word of data for each region based on the bit pattern associated with that color. In other words, the value of each word of data output by the processor is determined on a one-for-one basis by the color of the corresponding region on the sheet. This is the inverse operation of that described above for storing data. The same look-up table of colors can be used for retrieving and storing data.

The number of bits of data that can be stored on each page is given by the following formula:

$$NumberOfBits = \frac{DotsX}{2} * \frac{DotsY}{2} * BitsPerDot$$

where:

NumberOfBits=total number of bits saved on a sheet of paper

DotsX=number of dots printed along the X axis

DotsY=number of dots printed along the Y axis

BitsPerDot=number of bits per dot (e.g., 8 for an eight-bit word)

If dots are printed at a density of 600 dpi on a sheet of letter-size paper (8½×11 inches), this results in storage capacity in excess of 67 megabits per sheet. This storage capacity can be increased by using a higher dot density, or using fewer horizontal control lines 35 relative to the number of horizontal data lines 30 in FIG. 3. For example, the ratio of control lines 35 to data line 30 could be reduced from 1:1 to 1:3 or 1:100. The storage capacity could be further increase by storing more bits per dot. The preceding discussion has assumed an eight-bit word and a set of 28 or 256 unique colors. For example, this could be increased to a 10-bit word using a set of 210 or 1024 colors.

Storage capacity could also be increased by using the data storage processor 12 to apply a conventional data compression algorithm (e.g., LZW or PKZIP) to the data as an initial step before color-encoding the resulting compressed data. The data retrieval processor 18 then decompresses the data after color-decoding to restore the original dataset. Parity bits or error correction data can be added to the data as it is processed by the data storage processor 12 to verify the accuracy of data retrieval and to facilitate correction of any errors.

The above disclosure sets forth a number of embodiments of the present invention. Other arrangements or embodiments, not precisely set forth, could be practiced under the teachings of the present invention and as set forth in the following claims.

```
□%-12345X@PJL JOB
@PJL SET RESOLUTION = 600
@PJL SET BITSPERPIXEL = 2
@PJL SET ECONOMODE = OFF
@PJL SET HOLDKEY = “0000”
@PJL ENTER LANGUAGE = POSTSCRIPT
%!PS-Adobe-3.0
/Times-Italic findfont 30 scalefont setfont
/displayTitle
{
  170 750 moveto (Bit color definition) show
} def
/displayTitleBits
{
  /Times-Italic findfont 15 scalefont setfont
  0 0 1 setrgbcolor
  20 685 moveto (Bit 1) show
  80 685 moveto (Bit 2) show
  140 685 moveto (Bit 3) show
  200 685 moveto (Bit 4) show
  260 685 moveto (Bit 5) show
  320 685 moveto (Bit 6) show
  380 685 moveto (Bit 7) show
  440 685 moveto (Bit 8) show
}def
/displayTests
{
  0 0 0 setrgbcolor
  /Times-Italic findfont 25 scalefont setfont
  130 600 moveto (Tests with different bytes) show
}def
/drawBit30
{
  newpath
  setrgbcolor
  moveto
  60 0 rlineto
  0 −30 rlineto
  −60 0 rlineto
  closepath
  fill
}def
/color
{
  0 0 0 setrgbcolor
}def
1 .3 0 setrgbcolor
displayTitle
10 730 .2 0 0 drawBit30
70 730 .3 0 0 drawBit30
130 730 .4 0 0 drawBit30
190 730 0 .2 0 drawBit30
250 730 0 .3 0 drawBit30
310 730 0 .4 0 drawBit30
370 730 0 0 .2 drawBit30
430 730 0 0 .5 drawBit30
displayTitleBits
displayTests
/Times-Italic findfont 15 scalefont setfont
10 550 .9 .9 .7 drawBit30
color
200 530 moveto (1 1 1 1 1 1 1 1) show
10 520 0 0 0 drawBit30
color
200 500 moveto (0 0 0 0 0 0 0 0) show
10 490 .9 .2 0 drawBit30
color
200 470 moveto (1 1 1 1 0 0 0 0) show
10 460 0 .7 .7 drawBit30
color
200 440 moveto (0 0 0 0 1 1 1 1) show
10 430 .6 .3 .2 drawBit30
color
200 410 moveto (1 0 1 0 1 0 1 0) show
10 400 .3 .6 .5 drawBit30
color
200 380 moveto (0 1 0 1 0 1 0 1) show
10 370 .5 .7 0 drawBit30
color
200 350 moveto (1 1 0 0 1 1 0 0) show
10 340 .4 .2 .7 drawBit30
color
200 320 moveto (0 0 1 1 0 0 1 1) show
10 310 .2 0 .5 drawBit30
color
200 290 moveto (1 0 0 0 0 0 0 1) show
10 280 .7 .9 .2 drawBit30
color
200 260 moveto (0 1 1 1 1 1 1 0) show
showpage
□%-12345X@PJL EOJ
```

I claim:

1. A method for storing data on printed sheets, said method comprising:
dividing the data into a series of words, each word containing N bits of data, where N is a predetermined positive integer;
selecting a set of 2^{N} unique colors;
assigning a unique color to each possible value of a word; and
printing a series of regions on a sheet in a predetermined two-dimensional pattern, wherein each region corresponds to one word of data and the color of each region is determined by the unique color associated with the value of each word of data.

2. The method of claim 1 further comprising the step of printing information on the printed sheet defining parameters for retrieving data from the printed sheet.

3. The method of claim 1 wherein each unique color is created using a predetermined weighting of up to three primary colors.

4. The method of claim 1 further comprising the initial step of compressing the data.

5. The method of claim 1 wherein the regions are printed in a two-dimensional array.

6. The method of claim 5 wherein adjacent regions in the two-dimensional array are separated by a control line having a predetermined appearance.

7. The method of claim 6 wherein the control line comprises alternating regions having a predetermined appearances.

8. A system for storing data on a printed sheet comprising:
a processor dividing data into a series of words, each word containing N bits of data, where N is a predetermined positive integer; said processor further assigning a color for each word of data from a predetermined set of unique colors, said color being determined by the value of the word; and
a color printer controlled by the processor printing a series of regions on a sheet in a predetermined two-dimensional pattern, wherein each region corresponds to one word of data and the color of each region is determined by the processor.

9. The system of claim 8 wherein the processor further directs the printer to print information on the printed sheet defining parameters for retrieving data from the printed sheet.

10. The system of claim 8 wherein each unique color is created using a predetermined weighting of up to three primary colors.

11. The system of claim 8 wherein the regions are printed in a two-dimensional array.

12. The system of claim 11 wherein adjacent regions in the two-dimensional array are separated by a control line having a predetermined appearance.

13. The system of claim 8 wherein the processor compresses the data before dividing the data into words.

14. A system for retrieving data stored on a printed sheet as a two-dimensional pattern of colored regions, said system comprising:
a color scanner scanning a printed sheet; and
a processor processing color information from the scanner to determine the color of each of a two-dimensional pattern of regions on the sheet from a predetermined set of unique colors, said processor generating a word of digital data for each region containing a predetermined number of bits of data, the value of the each word of data being determined by the color of the corresponding region on the sheet.

15. The system of claim 14 wherein the processor initially reads information from a predetermined region of the printed sheet defining parameters for retrieving the remaining data from the printed sheet.

16. The system of claim 14 wherein each unique color consists of a predetermined weighting of up to three primary colors.

17. The system of claim 14 wherein the regions are printed in a two-dimensional array.

18. The system of claim 17 wherein adjacent regions in the two-dimensional array are separated by a control line having a predetermined appearance.

19. The system of claim 14 wherein the processor decompresses the data after generating the words of data.
